(19) United States
(12) Patent Application Publication
(10) Pub. No.: US 2009/0086317 A1
(43) Pub. Date: Apr. 2, 2009

(54) Reflective Screen

(75) Inventor: Hideki Etori, Saitama (JP)

Correspondence Address: BACON & THOMAS, PLLC, 625 SLATERS LANE, FOURTH FLOOR, ALEXANDRIA, VA, 22314-1176, US

(73) Assignee: KIMOTO CO., LTD., Tokyo (JP)

(21) Appl. No.: 11/920,151

(22) PCT Filed: May 1, 2006
(86) PCT No.: PCT/JP2006/309081

§ 371 Date: Nov. 9, 2007

(30) Foreign Application Priority Data
May 13, 2005 (JP) 2005-141091

(51) Int. Cl. G03B 21/56

(52) U.S. Cl. 359/449

(57) ABSTRACT

A reflective screen which can reflect images of high contrast, in particular, a reflective screen which can reflect images of higher contrast without increasing brightness of dark portions of projector images, even in a bright environment is provided. The reflective screen 7 comprises a polarized light selective scattering layer 3 showing stronger light scattering property for linearly polarized lights of a specific direction than for linearly polarized lights of which oscillation plane is a plane orthogonal to the oscillation plane of the linearly polarized light of the specific direction, and a light absorbing layer 2 for absorbing lights which transmit the polarized light selective scattering layer 3 provided on one surface of the polarized light selective scattering layer 3.

### TECHNICAL FIELD

The present invention relates to a reflective screen for projectors for reflecting image lights projected from a projector to display images on the screen, in particular, a reflective screen which can reflect high contrast images even in projection in a bright environment.

### BACKGROUND ART

There are known two-layer reflective screens provided with a reflecting layer for reflecting lights from a projector and a light diffusing layer for diffusing the reflected lights in order to reflect the lights projected from the projector to display images on the screens. Such two-layer reflective screens use a reflecting layer such as an aluminum vapor-deposited layer or an aluminum paste coating layer, so that lights reflected by this reflecting layer are further diffused by the light diffusing layer to enable observation of images with no glares in a comparatively wide viewing angle.

However, such reflective screens also reflect and diffuse lights from the surroundings (environmental lights) other than lights for images, when such lights is incident on the screens. Therefore, if projection is performed in a bright environment, there are reflected and diffused lights originated in environmental lights etc. also in dark portions of images. As a result, brightness of the dark portions is increased to reduce the contrast of the images, and the images become hard to see. The conventional only way to prevent this phenomenon is darkening the room. However, with spreading of projectors, reflective screens which can reflect high contrast images even in a bright environment have been increasingly desired.

Therefore, as shown in FIG. 1, there has been proposed a reflective screen 7 produced by successively forming a reflecting layer 5 for selectively reflecting lights of specific wavelengths (selective reflection layer) and a light diffusing layer 6 for diffusing reflected lights on a light absorbing substrate 1 (or light absorbing layer 2) as a reflective screen which can reflect high contrast images even in a bright environment (Patent document 1). Such a reflective screen selectively reflects only lights in the regions of the three primary colors of light constituting projector images, i.e., blue (B), green (G), and red (R), at the selective reflection layer, but transmits lights of the other wavelengths and absorbs them by the substrate, so as to suppress the increase of brightness of dark portions and thereby enable display of high contrast images even in a bright environment.

Patent document 1: Japanese Patent Unexamined Publication (Kokai) No. 2003-337381 (claim 1)

### DISCLOSURE OF THE INVENTION

### Problem to be Solved by the Invention

The reflecting layer of the reflective screen described in Patent document 1 is formed by alternately laminating many two kinds of transparent dielectrics of different refractive indices. Further, the film thickness of the dielectrics to be laminated is designed so that the optical film thickness (=refractive index×film thickness) should be ¼ of wavelength of lights to be reflected. Therefore, the film thickness of each dielectric becomes about 0.1 μm. However, it is difficult to uniformly laminate a large number of such thin films having a thickness of about 0.1 μm, and thus the reflective screen of Patent document 1 has a problem that it produces unevenness of color due to variation of reflection light wavelengths on the screen surface originating in the unevenness of the thickness of the dielectrics.

### Means for Solving the Problem

The inventor of the present invention conducted various researches in order to solve the foregoing problem. As a result, it was found that the aforementioned problem could be solved by using a specific reflective screen as a reflective screen used for projectors of which image lights are linearly polarized lights such as liquid crystal projectors.

Thus, the reflective screen of the present invention comprises a polarized light selective scattering layer showing stronger light scattering property for linearly polarized lights of a specific direction than for linearly polarized lights of which oscillation plane is a plane orthogonal to the oscillation plane of the linearly polarized light of the specific direction, and a light absorbing layer for absorbing lights which transmit the polarized light selective scattering layer provided on one surface of the polarized light selective scattering layer.

In the reflective screen of the present invention, the polarized light selective scattering layer and the light absorbing layer are preferably laminated without any air layer between them.

The reflective screen of the present invention is preferably provided with a mat layer disposed on the light incidence side with respect to the polarized light selective scattering layer.

### EFFECT OF THE INVENTION

The polarized light selective scattering layer of the reflective screen according to the present invention shows stronger light scattering property for linearly polarized lights of a specific direction (henceforth referred to as “specific polarized lights”) compared with light scattering property of the screen for linearly polarized lights of which oscillation plane is a plane orthogonal to the oscillation plane of the specific polarized light (henceforth referred to as “orthogonal polarized lights”). Therefore, it can made the polarization direction of linearly polarized lights projected from a projector conform to the direction along which the screen shows strong light scattering property, and thereby enables projection of images by scattering image lights. On the other hand, environmental lights are not polarized in a specific direction, and therefore they can be regarded as a mass of omnidirectionally linearly polarized lights, and considered to consist of two kinds of components having the same intensity, i.e., those having the same polarization direction as that of the specific polarized lights and those having the same polarization direction as that of the orthogonal polarized lights. Therefore, the reflective screen of the present invention shows strong light scattering property for the components of the environmental lights having the same polarization direction as that of the specific polarized lights, whereas it shows weak light scattering property for the components of the environmental lights having the same polarization direction as that of the orthogonal polarized lights. That is, among the environmental lights, scattering of one half of them by the polarized light selective scattering layer is suppressed, and the half lights transmit the polarized light selective scattering layer and are absorbed by the light absorbing layer. The increase of brightness of dark portions can be thereby suppressed, and thus high contrast images can be projected even in a bright environment.

Moreover, the reflective screen of the present invention does not cause color unevenness due to unevenness of thickness of the reflecting layer, and it provide favorable contrast in a bright environment with a structure comprising a few layers, i.e., two layers of the polarized light selective scattering layer and the light absorbing layer.

### BEST MODE FOR CARRYING OUT THE INVENTION

Hereafter, embodiments of the reflective screen of the present invention will be explained.

FIGS. 2 to 5 are sectional views showing embodiments of the reflective screen of the present invention. In FIGS. 2 to 5, the numerical symbol 1 denotes a substrate, 2 denotes a light absorbing layer, 3 denotes a polarized light selective scattering layer, 4 denotes an adhesive layer, 7 denotes a reflective screen, and 8 denotes a mat layer. In FIG. 4, a light absorbing layer 2 also functions as a substrate 1.

As shown in the drawings, the reflective screen of the present invention comprises the light absorbing layer 2 and the polarized light selective scattering layer 3 as essential components, and the polarized light selective scattering layer 3 is disposed on the light incidence side of the screen.

The substrate 1 functions as a support of the reflective screen. If the polarized light selective scattering layer 3 or the light absorbing layer 2 also functions as a support, it is not necessary to provide an individual substrate as shown in FIG. 4.

As the substrate, a transparent or opaque substrate consisting of glass, metal, resin or the like can be used. Examples of the resin include polycarbonate (PC), polyethylene terephthalate (PET), polyethylenenaphthalate (PEN), polyether sulfone (PES), polyolefin (PO), and so forth.

The polarized light selective scattering layer has a characteristic that it shows stronger light scattering property for the specific polarized lights than for the orthogonal polarized lights.

Example of the polarized light selective scattering layer having such a characteristic as described above include, for example, the anisotropic scattering device described in Japanese Patent No. 3090890, in which scattering particles having an aspect ratio of 1 or larger are arranged along one direction in a binder having a refractive index different from that of the scattering particles, the anisotropic scattering material described in Japanese Patent No. 3519130, in which a polymer/liquid crystal complex is oriented by stretching, and so forth.

Optical characteristics, i.e., light scattering property and light transmission, of such a polarized light selective scattering layer can be adjusted by, for example, adjusting difference of refractive indices of the binder and the anisotropic scattering device, density per unit area of the anisotropic scattering device (thickness of the scattering layer and ratio of the particles in the scattering layer), or aspect ratio (especially length of minor diameter) of the scattering particles.

The light scattering property can be determined on the basis of haze. Therefore, by choosing a haze of the polarized light selective scattering layer for specific polarized lights (henceforth also referred to as “haze for specific direction”) higher than haze of the polarized light selective scattering layer for orthogonal polarized lights (henceforth also referred to as “haze for orthogonal direction”), the light scattering property of the polarized light selective scattering layer for the specific polarized lights can be made stronger than the light scattering property for the orthogonal polarized lights. The haze for linearly polarized lights of the polarized light selective scattering layer can be measured by using a measurement apparatus defined in JIS K7136:2000 while disposing a polarization device before the light source so that lights entering into a sample should become linearly polarized lights.

A larger difference of the haze for specific direction and the haze for orthogonal direction is preferred for obtaining more favorable contrast. Specifically, it is preferably 30% or more, more preferably 40% or more. The haze for specific direction is preferably 70% or more, more preferably 80% or more. The haze for orthogonal direction is preferably 40% or less, more preferably 30% or less.

The total light transmission of the polarized light selective scattering layer for the specific polarized lights is preferably 70% or less, more preferably 60% or less. The total light transmission of the polarized light selective scattering layer for the orthogonal polarized lights is preferably 80% or more, more preferably 85% or more. The total light transmission of the polarized light selective scattering layer for linearly polarized lights can be measured by using a measurement apparatus defined in JIS K7361-1:1997 while disposing a polarization device before the light source so that lights entering into a sample should become linearly polarized lights.

A higher haze of the polarized light selective scattering layer for a specific direction provides stronger backward scattering property, i.e., stronger scattering on the light incidence side of the screen. In order to make backward scattering property stronger, a method of increasing the difference of refractive indices of the binder and the scattering particles, a method of increasing the density per unit area of the scattering particles, and so forth may be employed.

If the screen is disposed so that image lights projected from a projector, which are linearly polarized lights, should become specific polarized lights with respect to such a polarized light selective scattering layer, that is, the oscillation plane of the image lights from the projector should conform to the direction along which the polarized light selective scattering layer shows strong light scattering property, the polarized light selective scattering layer can scatter the image lights and thereby form images. In particular, such a polarized light selective scattering layer showing a low total light transmission for the specific polarized lights more scatters the entered lights backward (light incidence surface side), and therefore it can provide bright images. Moreover, the orthogonal polarized light components, which account for about a half of the environmental lights, are not hardly scattered by the polarized light selective scattering layer, but transmitted and absorbed on the light absorbing layer side. The increase of brightness in dark portions of projector images are thereby suppressed, and thus images of high contrast can be projected even in a bright environment.

Although the thickness of the polarized light selective scattering layer is not particularly limited, it is preferably 10 to 300 μm, if handling property of the screen, a case where the screen is made as a roll-up type screen, and so forth are taken into consideration.

The light absorbing layer is provided on one surface of the polarized light selective scattering layer. Such a light absorbing layer has a role of preventing decrease of contrast due to reflection of lights which transmit the polarized light selective scattering layer at the interface of the layer and the substrate or the like by absorbing image lights and environmental lights which transmit the polarized light selective scattering layer (lights which are not scattered backward by the polarized light selective scattering layer).

The light absorbing layer can be formed by coating a black paint or the like on one or both surfaces of the substrate mentioned above. Alternatively, as shown in FIG. 4, a substrate which per se is in a black color may be used, which was made black, for example, by mixing a light absorbing agent such as a black pigment in the substrate mentioned above.

The polarized light selective scattering layer and the light absorbing layer are preferably laminated without any air layer between them in order to prevent decrease of contrast. If an air layer is present between the polarized light selective scattering layer and the light absorbing layer, lights which transmit the polarized light selective scattering layer are reflected at the interface of the air layer and another layer before they are absorbed by the light absorbing layer, because of the large difference of refractive indices of the air layer and the other layer, and thus contrast is decreased. However, between the polarized light selective scattering layer and the light absorbing layer, another layer other than air layer such as a substrate or an adhesive layer may be provided, as shown in FIG. 3.

In order to laminate the polarized light selective scattering layer and the light absorbing layer without air layer between them, a method of adhering the polarized light selective scattering layer on one surface of the substrate via an adhesive layer and adhering the light absorbing layer on the other surface via an adhesive layer (FIG. 3), and a method of forming the light absorbing layer by applying a coating solution for the light absorbing layer on the polarized light selective scattering layer and drying the solution may be employed. If the polarized light selective scattering layer and the light absorbing layer are simply overlaid, an air layer would exist between both the layers to decrease contrast.

In the reflective screen of the present invention, a mat layer 8 may be provided on the surface of the polarized light selective scattering layer opposite to the surface on which the light absorbing layer is provided (light incidence surface) (FIG. 5). By providing a mat layer, reflection of lights directly coming from a light source of a projector can be prevented in projection using the projector. The mat layer surface preferably has an arithmetical mean deviation (Ra) according to JIS B0601:2001 of 1.0 μm or less, more preferably 0.7 μm or less, as for the upper limit. If Ra of the mat layer surface is 1.0 μm or less, increase of haze for the orthogonal direction due to unnecessarily roughened surface can be prevented. As for the lower limit, Ra of the mat layer surface preferably exceeds 0.3 μm, more preferably 0.4 μm.

The mat layer is not particularly limited so long as an uneven shape which can prevent reflection of lights from projector light source is formed on the mat layer surface, and those utilizing a matting agent, those imparted with unevenness on the surfaces by chemical etching or embossing, and so forth can be employed. As an example, configuration of a mat layer mainly consisting of a transparent binder and a matting agent will be explained.

The transparent binder may be one that is transparent and can uniformly retain the matting agent in a dispersed state, and examples include solids such as glass and polymer resins. However, in view of handling property, stability of the dispersed state, and so forth, polymer resins are preferred.

Glass used as the transparent binder is not particularly limited so long as the light transmission property of the light scattering layer is not lost. Examples of glass generally used include oxide glass such as silicate glass, phosphate glass and borate glass, and so forth. As the polymer resins used as the transparent binder, thermoplastic resins, thermosetting resins, ionizing radiation curable resins, such as polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, vinyl resins, polyethylene resins, polystyrene resins, polypropylene resins, polyamide resins, polyimide resins, melamine resins, phenol resins, silicone resins, and fluorocarbon resins, and so forth can be used.

As the matting agent, inorganic microparticles such as those of silica, alumina, talc, zirconia, zinc oxide, and titanium dioxide, and organic microparticles such as those of polymethyl methacrylate, polystyrene, polyurethane, benzoguanamine, and silicone resin can be used. Organic microparticles are particularly preferred in view of ease of obtaining spherical shape. Particle diameter of the matting agent is preferably about 0.1 to 10 μm in terms of an average particle diameter.

As for the weight ratio of the transparent binder and the matting agent in the mat layer, the matting agent is preferably used in an amount of 20 to 60 parts by weight, more preferably 30 to 50 parts by weight, with 100 parts by weight of the transparent binder.

Further, the mat layer is preferably in a black color. If a mat layer is simply provided, the haze for the orthogonal direction is increased, and contrast is thereby slightly decreased. However, use of a mat layer in a black color not only prevent the decrease of contrast but also increase contrast conversely.

Examples of the method for making the mat layer black include a method of incorporating a black pigment such as carbon black into the mat layer, and a method of utilizing a matting agent colored black. Among these, the method of utilizing a black matting agent is preferred, because contrast can be increased by this method without decreasing the screen gain (SG value) for the frontal direction. A black matting agent can be obtained by a method of mixing a black pigment such as carbon black in a resin constituting the matting agent, and then making the resin into particles, and so forth.

When the mat layer is not provided on the light incidence surface side of the polarized light selective scattering layer, it is preferred that the surface of the reflective screen on the polarized light selective scattering layer side is substantially smooth. In the present invention, the term “substantially smooth” means that the surface has an arithmetical mean deviation (Ra) according to JIS B0601:2001 of 0.30 μm or less, preferably 0.15 μm or less. By making the surface have an Ra value within such a range, the haze for the orthogonal direction originating in the surface shape can be made low, and contrast can be thereby made favorable.

In the reflective screen of the present invention, an anti-reflection layer may be provided as an uppermost layer. Decrease of light amount of images projected from a projector can be thereby prevented, and thus it comes to be possible to project brighter images on the screen. At the same time, reflection of unnecessary lights can be reduced, and thereby the screen can be made easier to see.

Moreover, a hard coat layer may also be provided as the uppermost layer of the reflective screen of the present invention. This makes it possible to prevent degradation of display quality due to scratching of the surface of the screen.

When both the anti-reflection layer and the hard coat layer are provided, it is preferable to provide the anti-reflection layer on the hard coat layer.

The reflective screen of the present invention having such a configuration as described above is especially effective for liquid crystal projectors of which image lights are linearly polarized lights. However, even in projectors of other types in which image lights are not linearly polarized lights, increase of contrast can be expected as in liquid crystal projectors, if projected image lights are passed through a polarization device and thereby made linearly polarized lights.

Furthermore, all the polarization directions of lights in the three primary color wavelength regions, R, G and B, constituting image lights may not be the same depending on the type of liquid crystal projector. In such a case, by passing the image lights through an optical device for rotating the polarization direction as required, the polarization directions can be made the same to exhibit the effect of the reflective screen of the present invention.

### EXAMPLES

### Example 1

Rod-shaped titanium oxide produced by Ishihara Sangyo Kaisha, Ltd. (major diameter: 1.7 μm, minor diameter: 0.13 μm) and a polymer compound consisting of a mixture of 2-ethylhexyl acrylate and a urethane type oligomer (weight ratio: 70:30) were mixed so that the weight ratio of titanium oxide and the polymer compound should be 2:1, and kneaded with 3 rollers to disperse titanium oxide. At that time, 2% by weight of benzophenone was added as a polymerization initiator.

Then, the aforementioned titanium oxide dispersed mixture was applied on a glass substrate, and subjected to ultraviolet irradiation for 2 minutes using a high-pressure mercury vapor lamp at an intensity of 20 mW/cm² (360 nm filter) for curing to obtain a resin mixture in a film shape having a thickness of 20 μm.

Subsequently, the obtained resin mixture in the form of a film was monoaxially stretched about two to three times to obtain a polarized light selective scattering layer. The obtained polarized light selective scattering layer was observed under a microscope, and it was found that titanium oxide was oriented along the stretching direction.

Then, on a black film having a thickness of 100 μm (Lumirror X30, Toray Industries, Inc.), a coating solution for adhesive layer having the following composition was applied for a dry thickness of 10 μm and dried, and the aforementioned polarized light selective scattering layer was laminated on the adhesive layer to obtain a reflective screen of Example 1.

<Coating solution for adhesive layer>

| | | |
|---|---|---|
| Acrylic type adhesive | 100 | parts |
| (Olibain BPS1109, | | |
| TOYO INK MFG. CO., LTD.) | | |
| Isocyanate type curing agent | 2.4 | parts |
| (Olibain BHS8515, | | |
| TOYO INK MFG. CO., LTD.) | | |
| Ethyl acetate | 100 | parts |

### Example 2

On the polarized light selective scattering layer of the reflective screen of Example 1, a coating solution for mat layer having the following composition was applied for a dry thickness of 2 μm and dried to form a mat layer and thereby obtain a reflective screen of Example 2. The mat layer surface had Ra of 0.63 μm.

<Coating solution for mat layer>

| | | |
|---|---|---|
| Acrylic resin (ACRYDIC A807, | 16.2 | parts |
| Dainippon Ink & Chemicals, Inc.) | | |
| Isocyanate type curing agent | 3.5 | parts |
| (Takenate D110N, Mitsui Chemicals | | |
| Polyurethanes, Inc.) | | |
| Transparent organic microparticles | 4.1 | parts |
| (Rubcouleur 230SM, Dainichiseika | | |
| Color & Chemicals Mfg. Co., Ltd., | | |
| average particle diameter: 3.7 μm) | | |
| Dilution solvent | 30.0 | parts |

### Example 3

On the polarized light selective scattering layer of the reflective screen of Example 1, a coating solution for black mat layer having the following composition was applied for a dry thickness of 2 μm and dried to form a black mat layer and thereby obtain a reflective screen of Example 3. The black mat layer surface had Ra of 0.56 μm.

<Coating solution for black mat layer>

| | | |
|---|---|---|
| Acrylic resin (ACRYDIC A807, | 16.2 | parts |
| Dainippon Ink & Chemicals, Inc.) | | |
| Isocyanate type curing agent | 3.5 | parts |
| (Takenate D110N, Mitsui Chemicals | | |
| Polyurethanes, Inc.) | | |
| Black organic microparticles | 4.1 | parts |
| (Rubcouleur 220SMD, Dainichiseika | | |
| Color & Chemicals Mfg. Co., Ltd., | | |
| average particle diameter: 3 μm) | | |
| Dilution solvent | 30.0 | parts |

### Comparative Example 1

On an aluminum vapor-deposited film, a light diffusing film (DILAD Screen WS, Kimoto Co., Ltd.) was laminated to obtain a reflective screen of Comparative Example 1.

On each of the reflective screens obtained in Examples 1 to 3 and Comparative Example 1, images were projected by using a liquid crystal projector (ELP-8000, Seiko Epson Corporation), of which image lights are linearly polarized lights, under illumination of a fluorescent light, and evaluation was performed for the following items. The results are shown in Table 1. Since the polarization direction of G image lights among the RGB image lights of the liquid crystal projector used for this evaluation was orthogonal to the other two polarization directions, an optical device for rotating only the polarization direction of G image lights by 90 degrees was installed so that all the polarization directions of three primary colors R, G and B should be the same. Further, for evaluation of the screens of Examples 1 to 3, the reflective screens were disposed so that the stretching direction of the polarized light selective scattering layer should be the same as the polarization directions of R, G and B image lights.

(1) Reflection of Lights from Projector Light Source

When reflection of lights from light source was not observed, the result was indicated with “◯”, and such reflection was observed, the result was indicated with “X”

### (2) Contrast

Contrast was measured in an environment where the illumination on the screen was 500 lx. The contrast was defined to be a ratio of brightness of white portions (bright portions) and black portions (dark portions) of projector images.

TABLE 1

| | Reflection of | |
|---|---|---|
| | lights from light | |
| | source | Contrast |
| Example 1 | X | 9 |
| Example 2 | ◯ | 8 |
| Example 3 | ◯ | 12 |
| Comparative Example 1 | X | 3 |

As seen from the results shown above, high contrast and favorable visibility were obtained with the reflective screens of Examples 1 to 3 even under a bright condition where the illumination on the screens was 500 lx. With the reflective screens of Examples 2 and 3, reflection of lights from the projector light source was not observed. In particular, the reflective screen of Example 3 could further improve the contrast compared with that of Example 1, and could prevent reflection of lights from projector light source at the same time.

On the other hand, the reflective screen of Comparative Example 1 was influenced by environmental lights, thus provided poor contrast, and could not provide visibility comparable to that provided with the screens of the examples. Moreover, it could not prevent reflection of lights from the projector light source.

When projection was performed with the projector on the reflective screens of Examples 1 to 3 in such a state that the stretching direction of the polarized light selective scattering layer should be orthogonal to the polarization directions of R, G and B, contrast was low, and visibility was poor.

### BRIEF DESCRIPTION OF THE DRAWINGS

FIG. 1 A sectional view showing a conventional reflective screen.

FIG. 2 A sectional view showing an example of the reflective screen of the present invention.

FIG. 3 A sectional view showing another example of the reflective screen of the present invention.

FIG. 4 A sectional view showing another example of the reflective screen of the present invention.

FIG. 5 A sectional view showing another example of the reflective screen of the present invention.

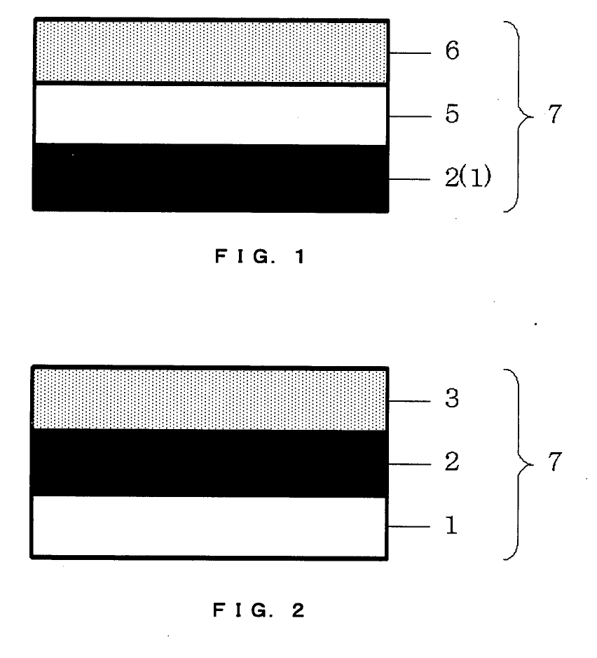

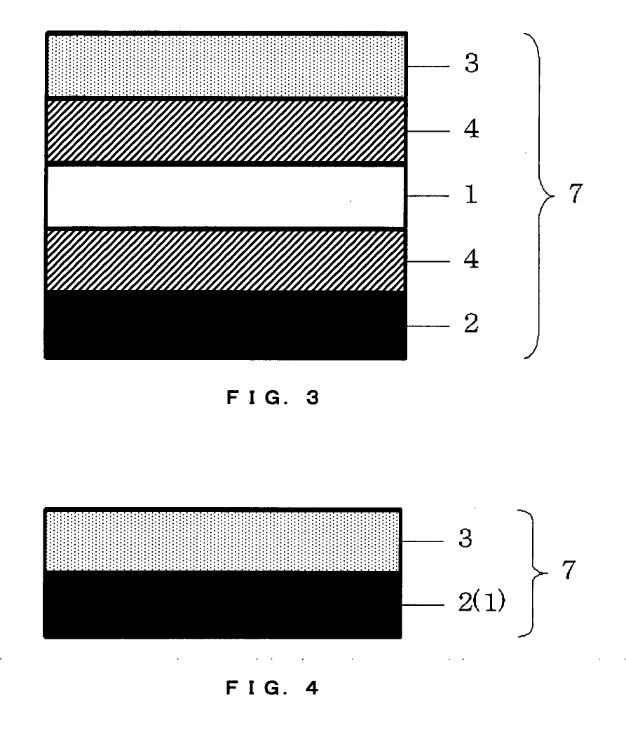

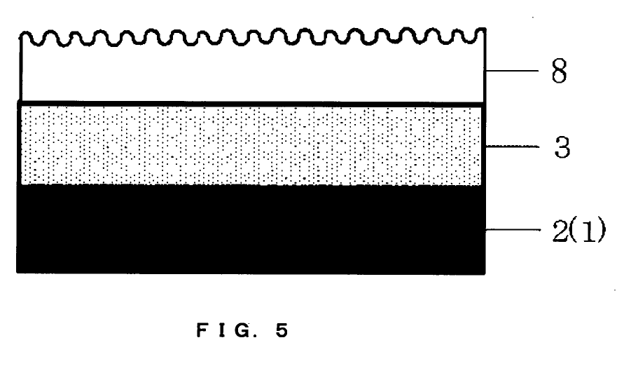

### DESCRIPTION OF NOTATIONS

1 . . . Substrate
2 . . . Light absorbing layer
3 . . . Polarized light selective scattering layer
4 . . . Adhesive layer
5 . . . Selective reflection layer
6 . . . Light diffusing layer
7 . . . Reflective screen
8 . . . Mat layer

1. A reflective screen comprising a polarized light selective scattering layer showing stronger light scattering property for linearly polarized lights of a specific direction than for linearly polarized lights of which oscillation plane is a plane orthogonal to the oscillation plane of the linearly polarized light of the specific direction, and a light absorbing layer for absorbing lights which transmit the polarized light selective scattering layer provided on one surface of the polarized light selective scattering layer.

2. The reflective screen according to claim 1, wherein the polarized light selective scattering layer and the light absorbing layer are laminated without any air layer between them.

3. The reflective screen according to claim 1, wherein the polarized light selective scattering layer is disposed on the light incidence side with respect to the light absorbing layer.

4. The reflective screen according to claim 3 which is provided with a mat layer on the light incidence side with respect to the polarized light selective scattering layer.

5. The reflective screen according to claim 4, wherein the mat layer is in a black color.

6. The reflective screen according to claim 2, wherein the polarized light selective scattering layer is disposed on the light incidence side with respect to the light absorbing layer.

7. The reflective screen according to claim 6 which is provided with a mat layer on the light incidence side with respect to the polarized light selective scattering layer.

8. The reflective screen according to claim 7, wherein the mat layer is in a black color.

9. The reflective screen according to claim 1 which is provided with a mat layer on the light incidence side with respect to the polarized light selective scattering layer.

10. The reflective screen according to claim 9, wherein the mat layer is in a black color.

11. The reflective screen according to claim 2 which is provided with a mat layer on the light incidence side with respect to the polarized light selective scattering layer.

12. The reflective screen according to claim 11, wherein the mat layer is in a black color.
